(19) United States
(12) Patent Application Publication
(10) Pub. No.: US 2008/0157589 A1
(43) Pub. Date: Jul. 3, 2008

(54) POWER LINE RADIO FREQUENCY SIGNAL INTERFACE WITH CONSUMER PROTECTION AND FILTERING PRODUCTS

(75) Inventor: Richard N. Marsh, Cool, CA (US)

Correspondence Address: LARIVIERE, GRUBMAN & PAYNE, LLP, 19 UPPER RAGSDALE DRIVE, SUITE 200, MONTEREY, CA, 93940, US

(73) Assignee: Monster, LLC, Las Vegas, NV (US)

(21) Appl. No.: 11/965,014

(22) Filed: Dec. 27, 2007

Related U.S. Application Data
(60) Provisional application No. 60/882,480, filed on Dec. 28, 2006.

(51) Int. Cl. H04B 3/54

(52) U.S. Cl. 307/1

(57) ABSTRACT

An enhanced interface between typical utility power line protection and filtering products which is capable of passing both conditioned power and desired control commands and audio and video signals to the same outlet. Products used within the home which may be benefitted by the present invention include, but are not limited to, audio devices, visual devices, and computers.

This non-provisional application is based on and claims priority to U.S. Provisional Application Ser. No. 60/882,480, filed Dec. 28, 2006.

### TECHNICAL FIELD

The present invention relates to power voltage protection devices for consumer-attached electronic devices. More particularly it applies to input power filters associated with power protection devices having power line controls. Even more particularly, it applies to enhanced power protection equipment capable of passing a desired radio frequency signal to power-protected outlets.

### BACKGROUND ART

The problem sought to be over-come is that any data or radio frequency (RF) signal on the AC utility power line will be attenuated or suppressed by typical broadband filters used to clean the utility power lines of noise and unwanted signals. These unwanted signals come from other equipment sharing the same utility power, such as, motors, computers, and kitchen appliances. Thus, the desired signals for passing control commands, audio and video or other coded signals, get stripped from the line along with the undesired (noise) frequencies.

Another problem with passing the desired signal through to the outlet is that, besides the existing filter circuits, the protection circuits themselves may attenuate the desired signals. This is especially true if metal oxide varistor (MOV) protection devices are used across the AC utility lines (Line and Neutral wires) because a MOV has significant capacitance (Cp) to shunt/attenuate the desired signals.

What is needed is a power protection device, also known as a power center, enhanced power strip, and the like, that provides to a protected consumer product conditioned power without undesirable characteristics while faithfully providing the inputted desirable radio frequency commands, identification data and the like.

### DISCLOSURE OF THE INVENTION

Accordingly, the present invention is an enhanced interface between typical 50-60 Hz AC utility power line protection and filtering products used to protect connected equipment which is capable of passing both conditioned power and desired RF signals to the same outlet as protection and filtering circuits on the AC utility power line, herein referred to as a Power Line Control (PLC). Such RF signals are for passing control commands and audio and video signals for consumer use within the home (but is not limited to that application), such as for the HomePlug-standards use. Products used within the home which may be benefitted by the present invention include, but are not limited to, audio devices, visual devices, and computers. As used herein, RF is intended and understood to include all frequencies suitable for encoding and carrying data either electronically or optically.

The new circuit causes desired control/audio/video/data signals to bypass or go around the existing power line conditioning filters for protecting against incoming high voltage and filters noise from the utility AC and sums the desired signals back onto the AC utility lines at one or more output/outlet.

It is anticipated that in some protection schemes, with or without including line only filtering and/or connected equipment to connected equipment filtering, it will be possible to use only one-half the circuit to be effective in passing control/audio/video signals, as would be the case, for example, when MOV protection devices are not used between Line and Ground and between Neutral and Ground.

This new consumer circuit is a means to protect attached devices from high voltages and other undesired power conditions and to pass the desired signals unattenuated and also attenuate the undesired signals or frequencies in a selective manner. This is accomplished by adding series inductance on each AC utility wire at the input and output of such protection/filtering product. The inductance buffers or adds a high impedance to the desired signals so that they will take the path of least resistance through properly selected capacitors instead of going through the normal path which would attenuate the desired signal frequencies

Another feature of the present invention uses an MOV for protection of the desired signal but not attenuating the desired signal frequencies. This is accomplished by inserting a series inductance with the MOV to buffer (high impedance) the desired RF signal from the MOV capacitance over the range of frequencies desired.

### BRIEF DESCRIPTION OF THE DRAWING

For a better understanding of the present invention, reference is made to the below referenced accompanying Drawing. Reference numbers refer to the same or equivalent parts of the present invention throughout the several figures of the Drawing.

FIG. 1 is an exemplary Power Line Control (PLC) interface electrical one-line drawing in accordance with the present invention.

FIG. 2 is a conceptual PLC electrical one-line drawing in accordance with the present invention.

FIG. 3 is an exemplary PLC electrical one-line drawing in accordance with the present invention showing series noise filtering.

FIG. 4 is an exemplary PLC electrical one-line drawing in accordance with the present invention showing parallel noise filtering.

FIG. 5 is two exemplary PLC electrical one-line drawings in accordance with the present invention showing alternative embodiments for power conditioning.

FIG. 6 is an exemplary PLC electrical one-line drawing in accordance with the present invention showing conditioning and filtering isolation.

FIGS. 7 and 7A-7D are exemplary PLC electronic schematics in accordance with the present invention showing an exemplary display board suitable for use with the present invention, wherein FIG. 7 merely shows the relationship between FIGS. 7A-7D.

FIG. 8 is an exemplary PLC electronic schematic in accordance with the present invention showing an exemplary EMI board suitable for use with the present invention.

FIGS. 9 and 9A-9E are exemplary PLC electronic schematics in accordance with the present invention showing an exemplary surge board suitable for use with the present invention, wherein FIG. 9 merely shows the relationship between FIGS. 9A-9E.

### MODES FOR CARRYING OUT THE INVENTION

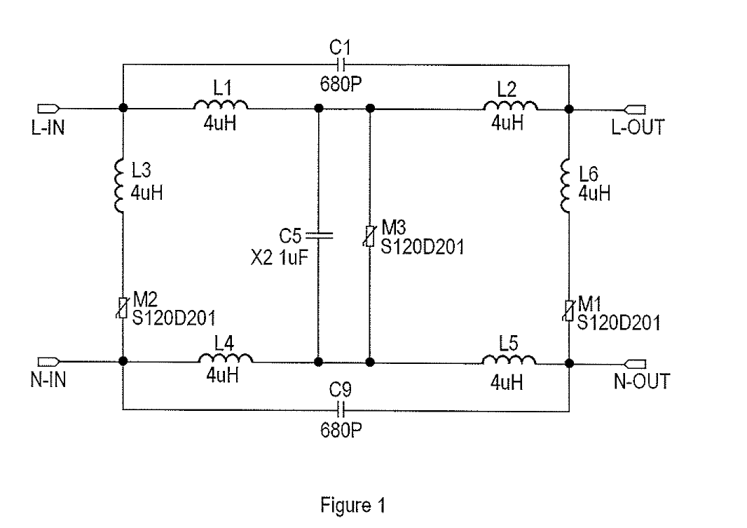

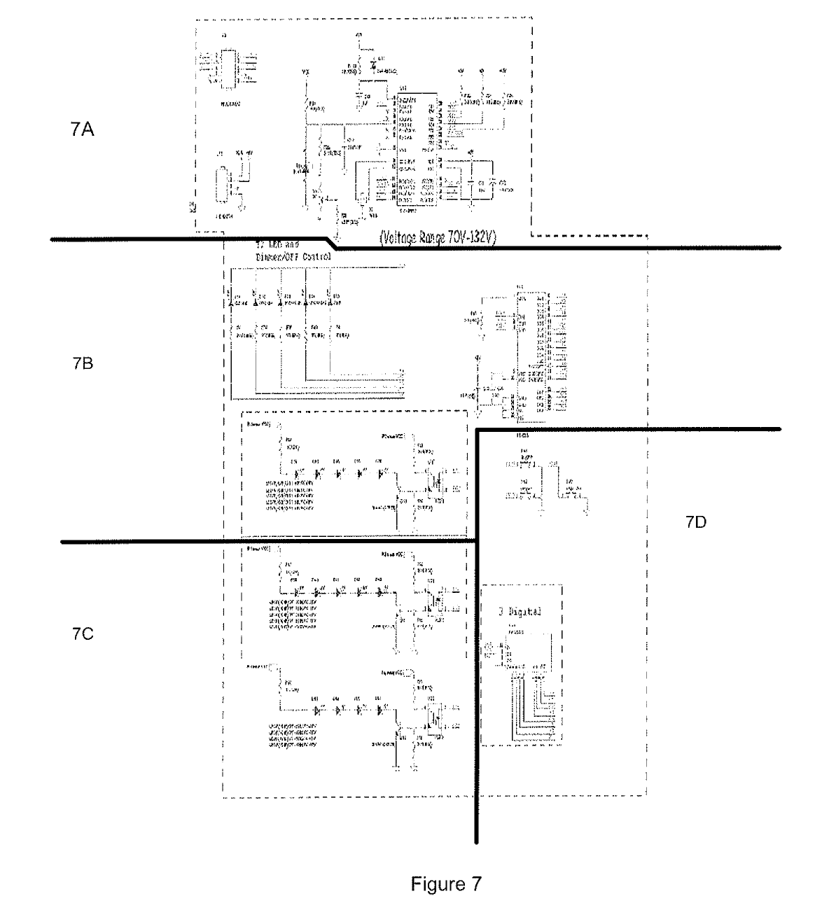

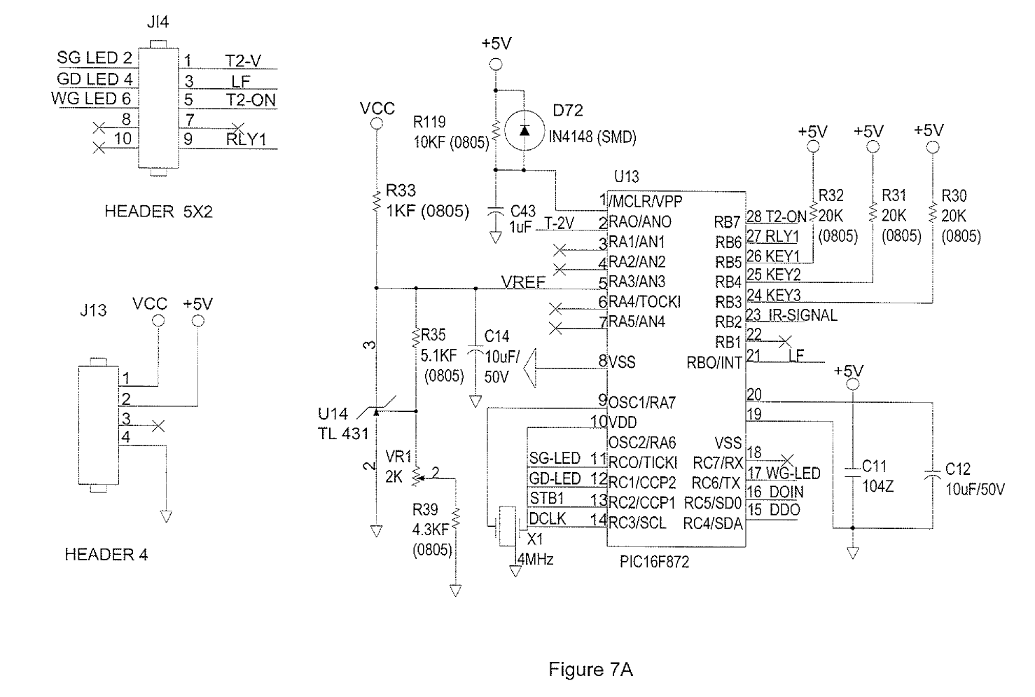

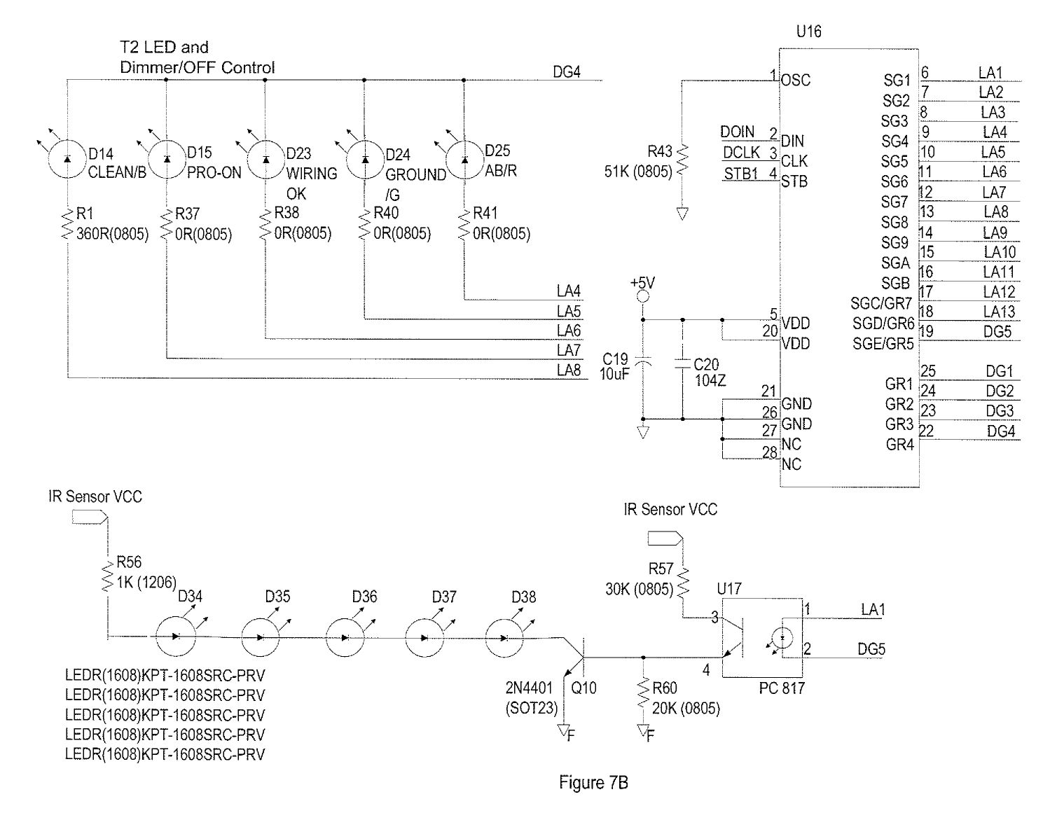

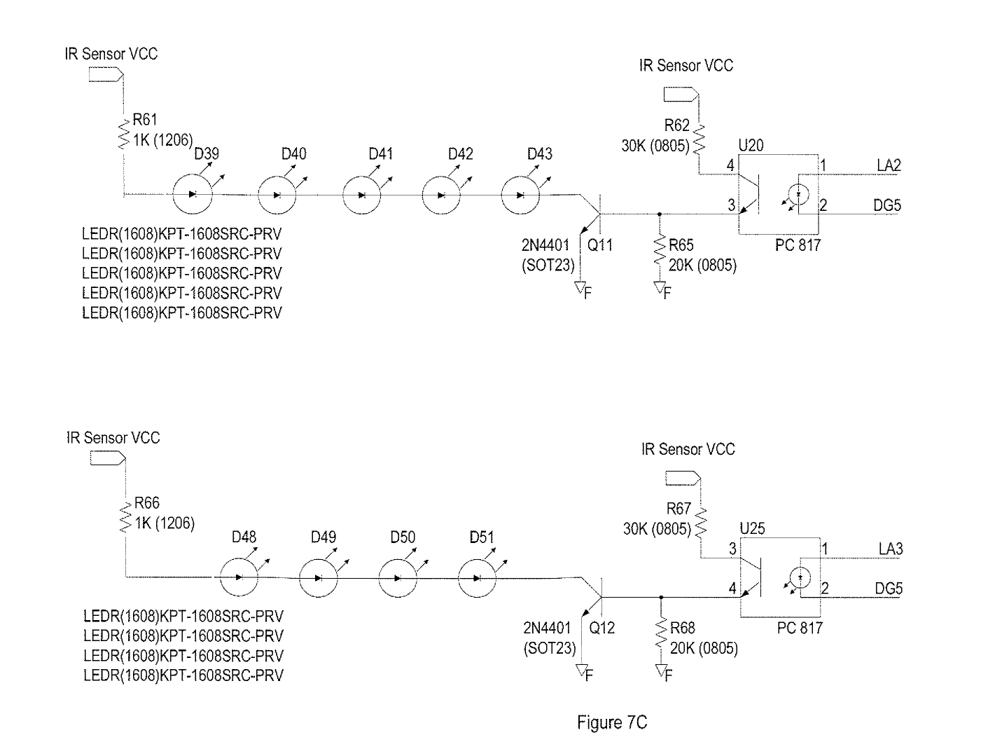

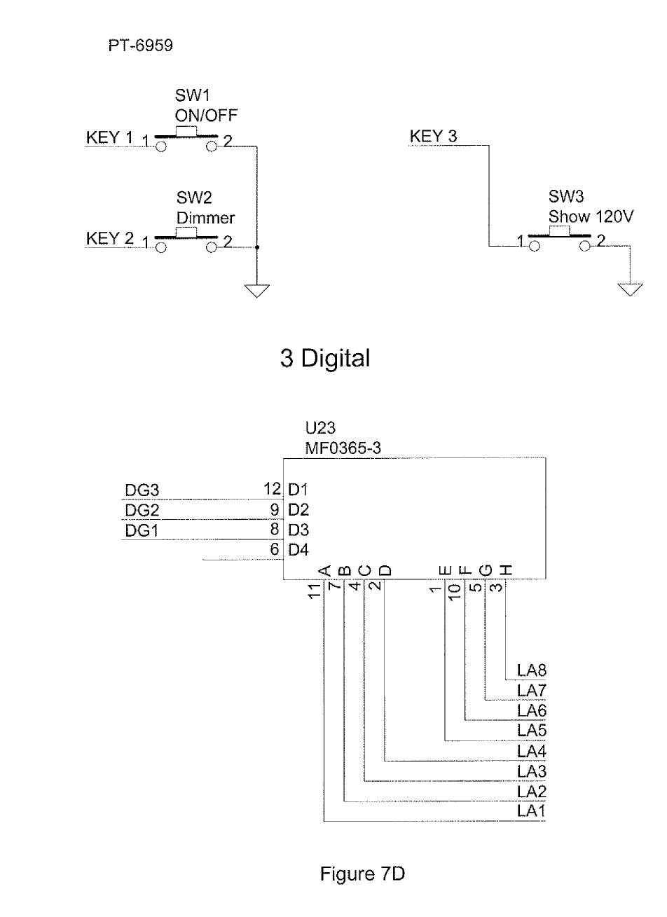

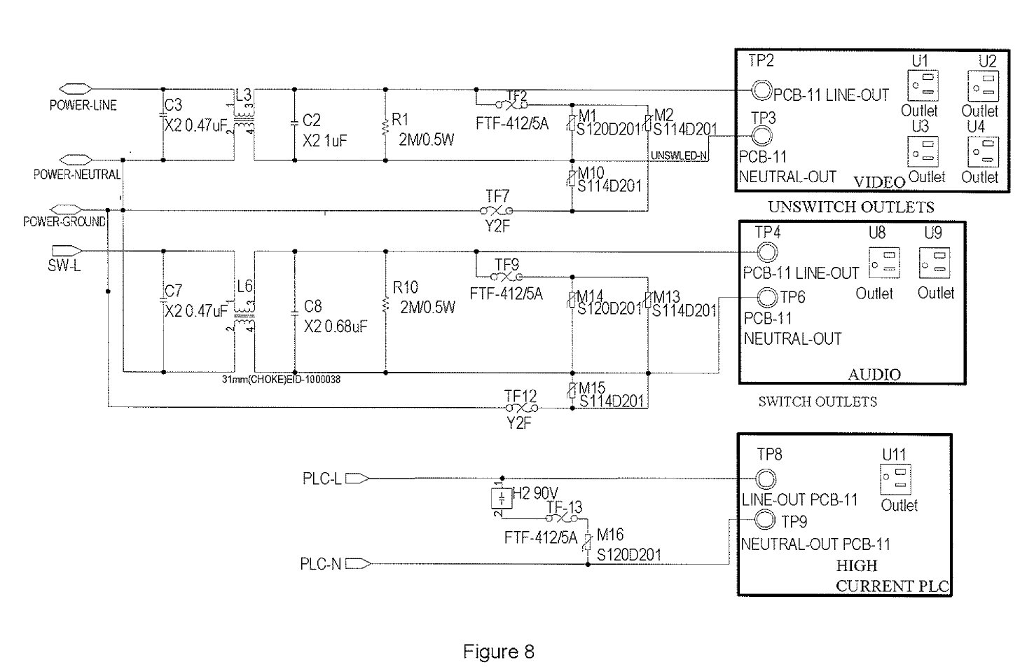

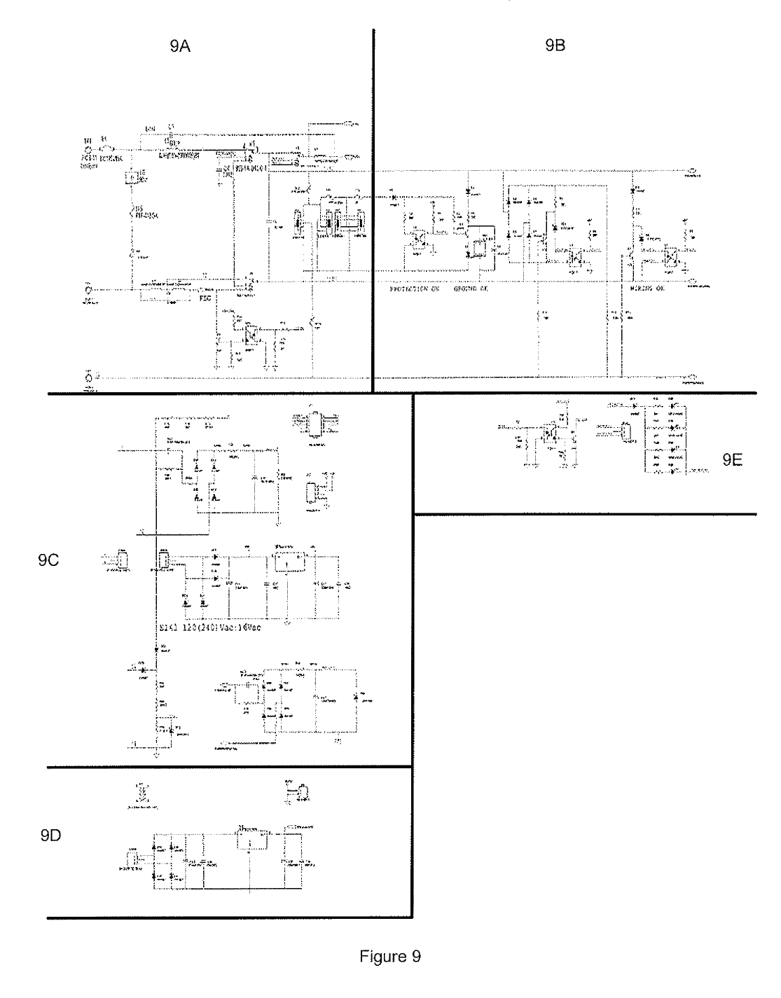

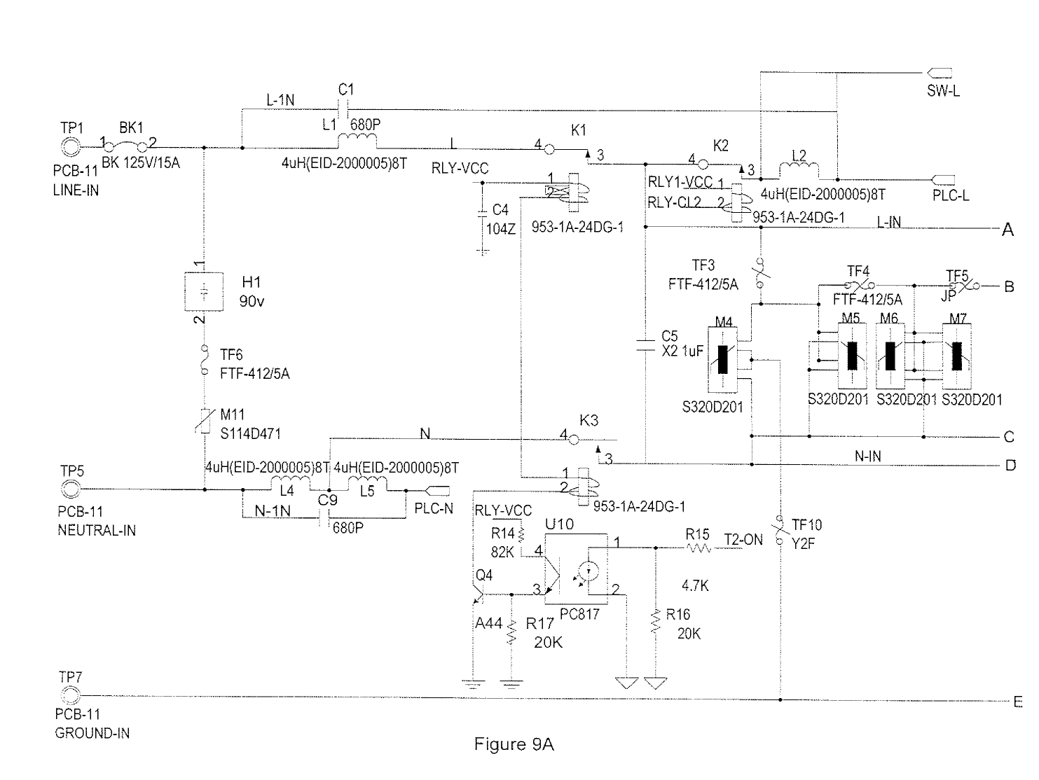

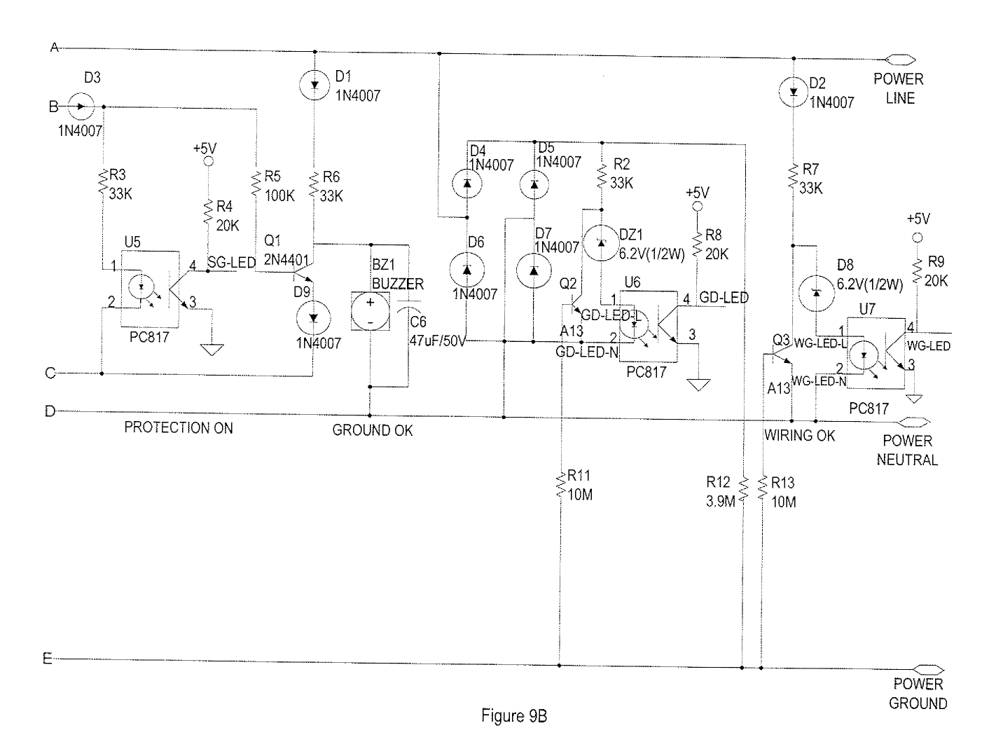

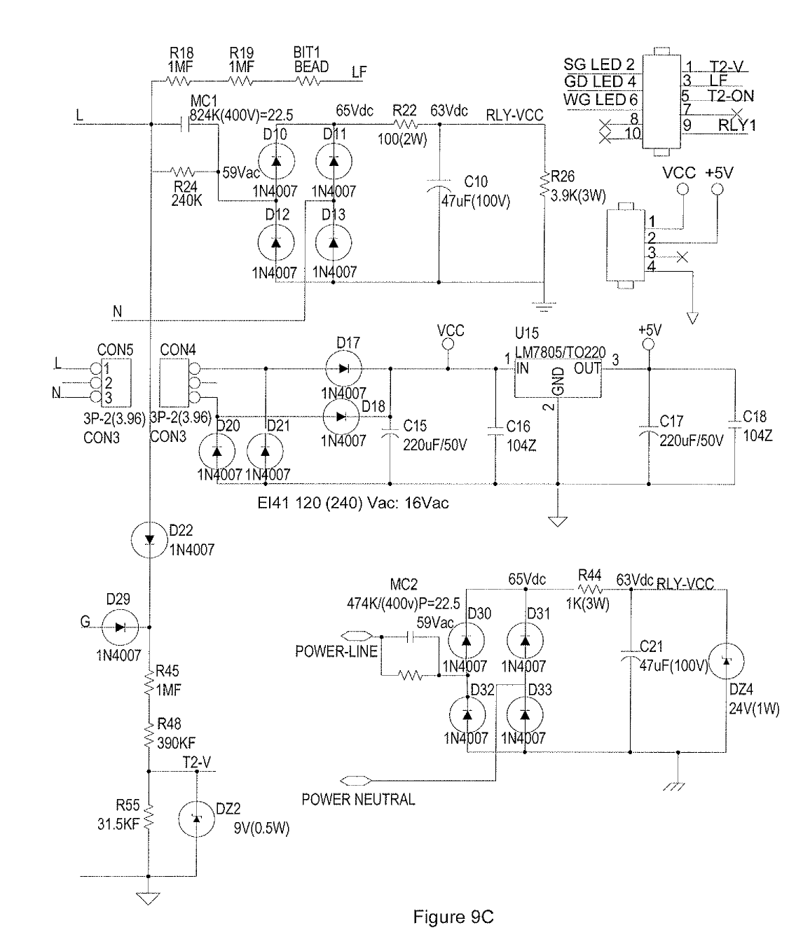

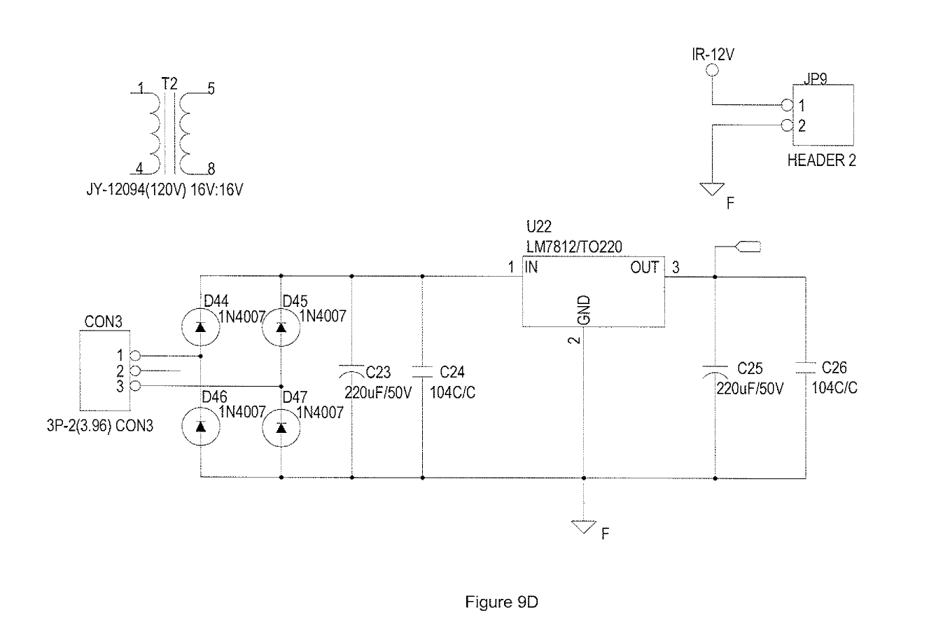

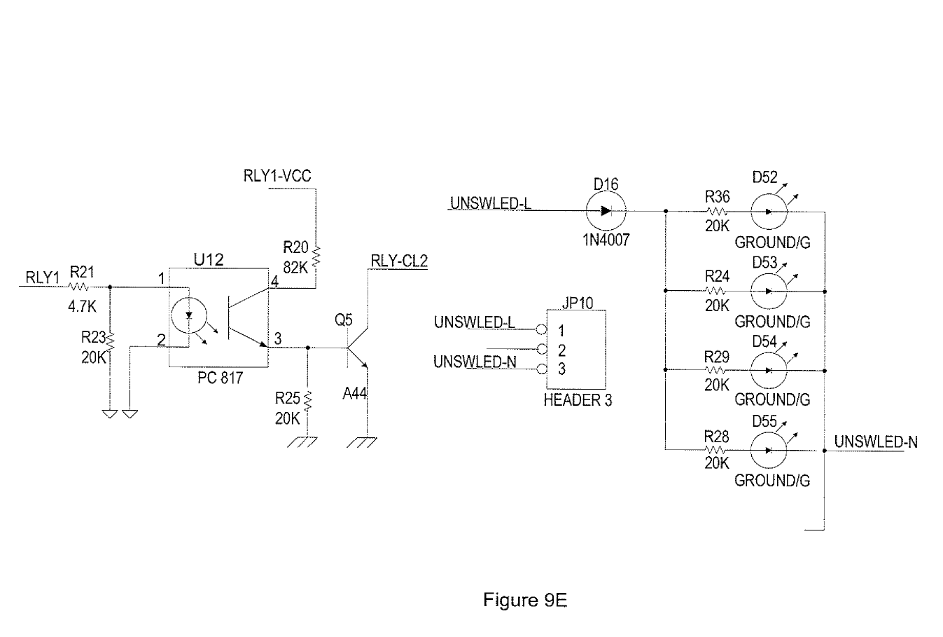

The above figures and the following description of the invention are presented in electrical engineering terminology and practices. FIGS. 1-6 are one-line drawings, showing only the essential features while assuming that the conventional elements, such as grounds, neutrals, circuit breakers, etc. will be recognized by other electrical engineers and will be included in the finished product as required by electrical codes and good engineering practice. As one-line drawings, they are not intended to be detailed literal wiring instructions. The one-line drawings convey the concept of the invention; selection of actual component values for individual RF signals, depends on the frequencies involved and are not necessarily shown in all figures. The reader is cautioned to recognize that the above FIGS. 1-6 are not to be interpreted as containing all elements of the schematic in the manner of electronic engineering practices. FIGS. 7-9 are, however, actual electronic schematics for a HDP 2400 Surge Board for a PLC in accordance with the present invention.

The circuit described herein is an interface between typical 50-60 Hz AC utility power line protection and filtering products used to protect connected equipment and passing desired RF signals to the same outlet or outlets as power provided by the protection and filtering circuits on the AC utility power line. The RF signal is for passing control commands and audio and video signals for consumer use within the home, but is not limited to that application. The utility power line protection and filtering products provide conditioned electrical power to at least one electrical outlet as is known in the art. The power conditioning components affect at least one of the power characteristics selected from but not limited to a group consisting of over voltage, under voltage, excessive current, insufficient current, incorrect phase relationship, noise, and incorrect cycle frequency.

Referring to FIG. 1, the combined circuit of protection and filtering for unwanted frequencies with the desired signal bypass and having additional protection for the wanted signals is modeled as shown and shown in the detailed electronic engineering circuit schematics of FIGS. 7-9. A second method of input/output high voltage protection instead of the MOV with series inductor L3 and L6 would have a Gas Discharge Tube (GDT) in series with the MOV in place of the inductor. The GDT would be inserted in place of L3 and L6 of FIG. 1. This method lowers the total shunt capacitance and thus keeps the desired RF from being attenuated. It does so because the capacitance of the GDT is about 2 pf. This was tested on 29 Jun. 2006.

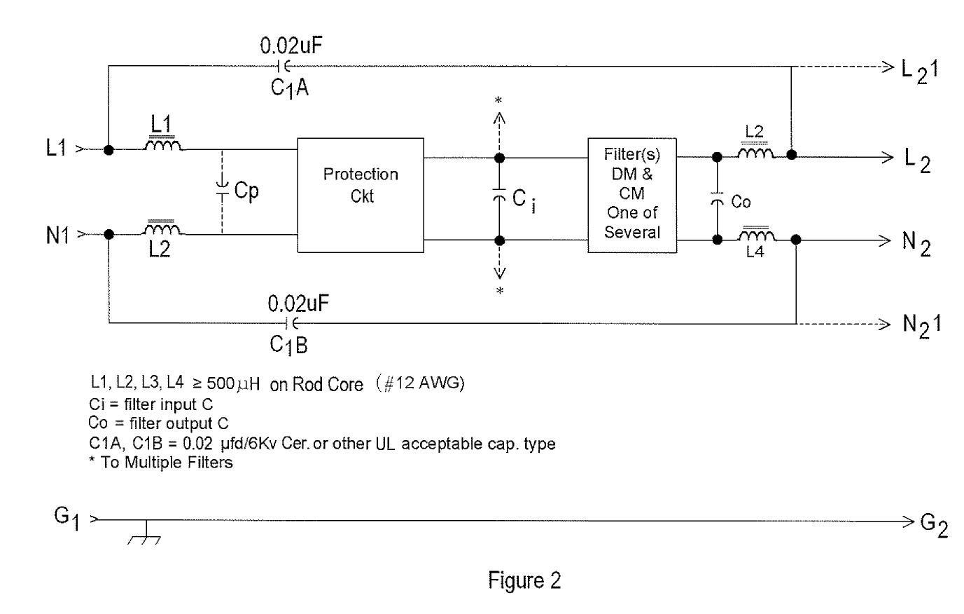

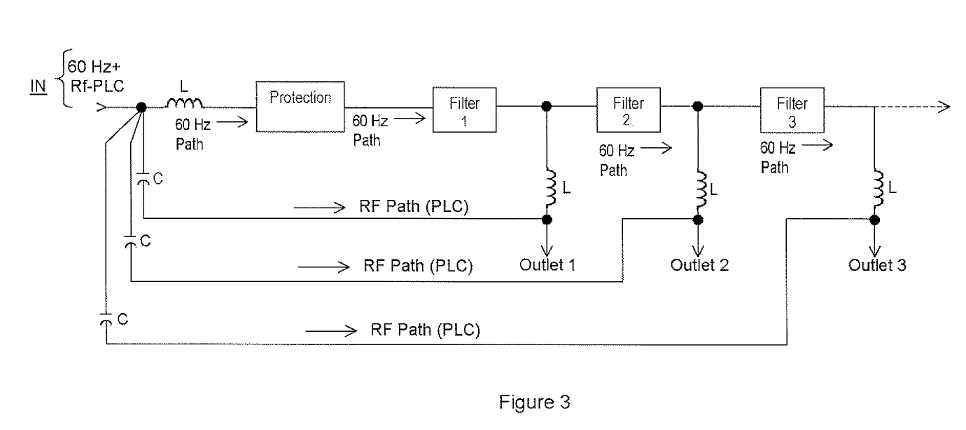

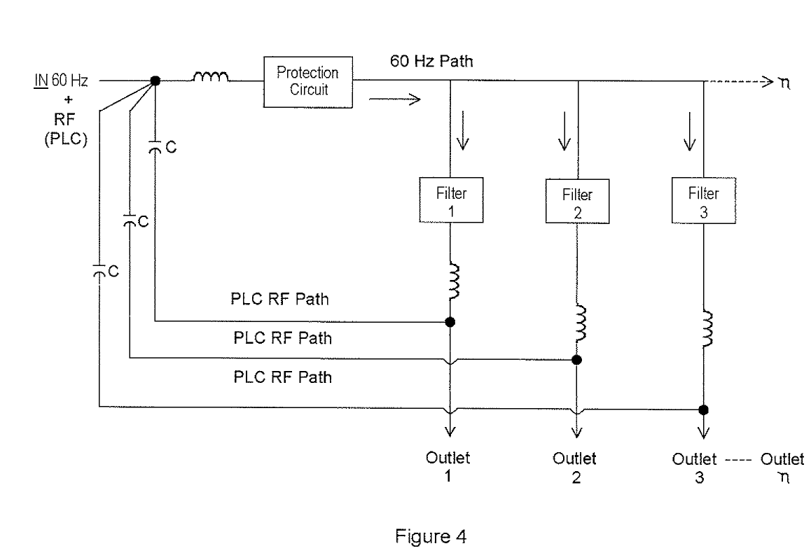

Referring to FIGS. 2-4, this preferred exemplary new consumer circuit is a means to protect from high voltages and to pass the desired signals unattenuated and also attenuate the undesired signals or frequencies in a selective manner. As shown in FIGS. 2 and 3, this is accomplished by adding series inductance on each AC utility wire (L1-L4) at the input and output of such protection/filtering product. The inductance will buffer or add a high impedance to the desired signals so that they will take the path of least resistance through C₁A and C₁B instead of going through the normal path which would attenuate the desired signal frequencies. In some applications, the parallel configuration of FIG. 4 may be preferred. In both configurations, serial or parallel, the capacitors may be individually switch selected or one capacitor may be assigned to any one selected outlet.

The new circuit causes desired control/audio/video/data signals to bypass or go around the existing protection circuit (protection against incoming high voltage etc.) and noise filter(s) from the utility AC and sums the desired signals back onto the AC utility lines at the output/outlet(s).

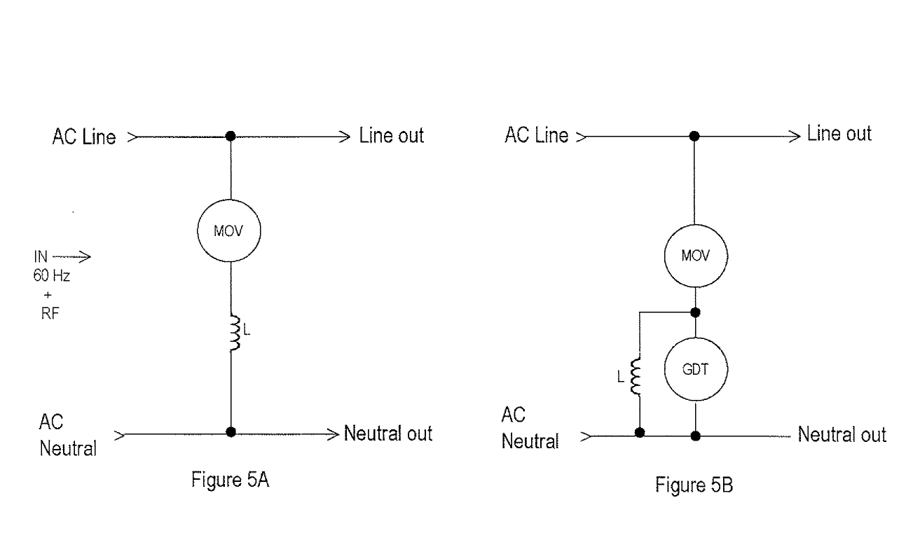

Another problem with passing the desired signal through to the outlet is that, besides the existing filter circuits, the protection circuits themselves may attenuate the desired signals. This is especially true if MOV protection devices are used across the AC utility lines (Line and Neutral wires) because an MOV has significant capacitance (Cp) to shunt/attenuate the desired signal. FIG. 5 shows two exemplary circuits for use of an MOV for protection of the desired signal but not attenuating the desired signal frequencies. This is accomplished by inserting a series inductance with the MOV, and in some circumstances a GDT, to buffer (high impedance) the desired RF signal from the MOV capacitance over the range of frequencies desired.

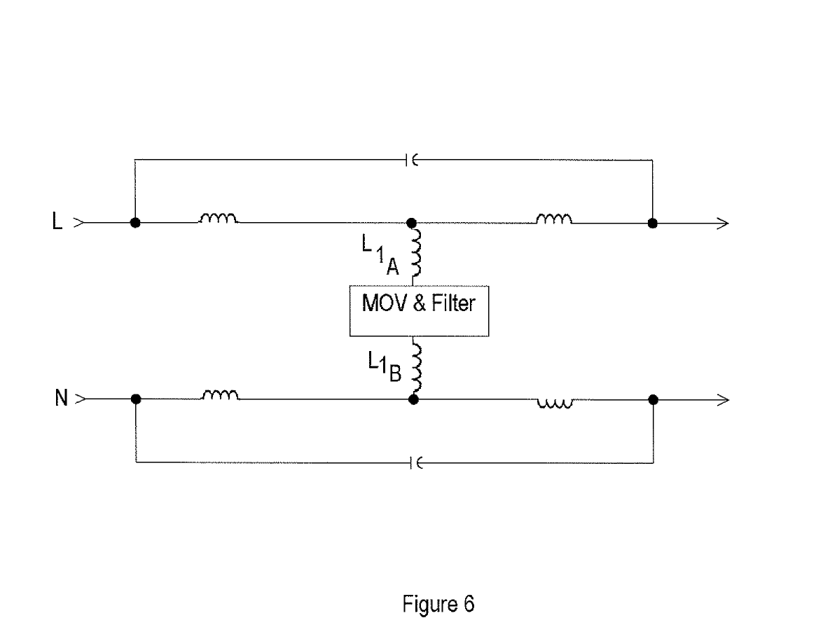

Referring to FIG. 6, showing isolation of the PLC from the power protection and filtering circuitry, it is anticipated that in some protection schemes, with or without including line-only filtering and/or connected equipment to connected equipment filtering, it will be possible to use only one-half the circuit to be effective in passing control/audio/video signals, that is, only L1-L3 and C1a. As would be the case, for example, when MOV protection devices are not used between Line and Ground and between Neutral and Ground.

FIGS. 7A-7D, 8 and 9A-9E are exemplary electronic schematic diagrams incorporating the present disclosure as used in a Pro Power 3600 Power Center™ with Clean Power™ available from Monster Cable Products, Inc., Burlingame, Calif.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.”

All structural and functional equivalents to the elements of the above-described preferred embodiment and additional embodiments that are known to those of ordinary skill in the art are hereby expressly incorporated by reference and are intended to be encompassed by the present claims. However, it should be readily apparent to those of ordinary skill in the art that various changes and modifications in form, apparatus material, and fabrication material detail may be made without departing from the spirit and scope of the invention as set forth in the appended claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. No claim herein is to be construed under the provisions of 35 U.S.C. 112, sixth paragraph, unless the element is expressly recited using the phrase “means for.”

### INDUSTRIAL APPLICABILITY

The present invention applies industrially to consumer electrical power protection devices. Even more particularly, the present invention applies to power centers that provide electrical power while additionally faithfully passing through desired data. The present invention uses commercially available components.

What is claimed:

1. An enhanced power center comprising:
power conditioning components for conditioning incoming electrical power and routing conditioned power to at least one outlet; and
radio frequency receiver components for receiving incoming data signals and routing them unaltered to the at least one power outlet.

2. A power center as recited in claim 1 wherein the incoming RF data signals are routed around the power conditioning components.

3. A power center as recited in claim 1 wherein the power conditioning components affect at least one of the power characteristics selected from the group consisting of over voltage, under voltage, excessive current, insufficient current, incorrect phase relationship, noise, and incorrect cycle frequency.

4. A power center as recited in claim 2 wherein the power conditioning components affect at least one of the power characteristics selected from the group consisting of over voltage, under voltage, excessive current, insufficient current, incorrect phase relationship, and incorrect cycle frequency.

5. An enhanced power center comprising:
power conditioning components for conditioning incoming electrical power and routing conditioned power to at least one outlet; and
radio receiver components for receiving incoming data signals and routing them unaltered around the power conditioning components to the at least one power outlet.

6. A power center as recited in claim 5 wherein the power conditioning components affect at least one of the power characteristics selected from the group consisting of over voltage, under voltage, excessive current, insufficient current, incorrect phase relationship, noise, and incorrect cycle frequency.

7. A method of providing an enhanced electrical power to a consumer product, comprising the steps of:
providing power conditioning components for conditioning incoming electrical power and routing conditioned power to at least one outlet; and
providing radio frequency receiving components for receiving incoming data signals and routing them unaltered to at least one power outlet.

8. A method as recited in claim 7 further including routing the incoming data signals around the power conditioning components.

9. A method as recited in claim 7 further including providing power conditioning components to affect at least one of the power characteristics selected from the group consisting of over voltage, under voltage, excessive current, insufficient current, incorrect phase relationship, noise, and incorrect cycle frequency.

10. A method as recited in claim 8 further including providing power conditioning components to affect at least one of the power characteristics selected from the group consisting of over voltage, under voltage, excessive current, insufficient current, incorrect phase relationship, noise, and incorrect cycle frequency.
